(19) United States
(12) Patent Application Publication
(10) Pub. No.: US 2020/0410367 A1
(43) Pub. Date: Dec. 31, 2020

(54) Scalable Predictive Analytic System

(71) Applicant: TD Ameritrade IP Company, Inc., Omaha, NE (US)

(72) Inventors: Aaron Andrew BLOMBERG, Bennington, NE (US); Mitchel William WEILER, Omaha, NE (US); Chris Raymond JENNINGS, Omaha, NE (US)

(21) Appl. No.: 16/458,148

(22) Filed: Jun. 30, 2019

(51) Int. Cl. G06N 5/02; G06N 20/00; G06Q 40/06

(52) U.S. Cl. CPC G06N 5/02; G06Q 40/06; G06N 20/00

(57) ABSTRACT

A system for validating models for predicting a client behavior event includes a development module and a validation module. The development module is configured to receive a use case corresponding to the client behavior event and select a subset of variables correlated to the client behavior event. The validation module is configured to select a first model from models that predict client behavior event using the selected subset of variables. The development module selects the first model based on a predicted lift of the first model. The validation module applies the first model to client data acquired subsequent to the selection of the first model. The validation module compares the predicted lift of the first model to an actual lift of the first model as applied to the client data. The validation module selects one of the first model and a different model in response to the comparison.

### FIELD

The present disclosure relates to computerized analytics systems and more particularly to computerized analytics systems using machine learning models.

### BACKGROUND

Computerized investment systems (e.g., online or electronic trading systems) provide various services to clients to facilitate the trading of investment products such as shares of stocks. The financial investment systems may monitor, collect, and store data client data including, but not limited to, transactional data (e.g., data about trades conducted by respective clients) and data indicative of client behavior.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A system for validating models for predicting a client behavior event includes a development module and a validation module. The development module is configured to receive a use case corresponding to the client behavior event and select a subset of variables correlated to the client behavior event. The validation module is configured to select a first model from a plurality of models. Each of the plurality of models is configured to predict the client behavior event using the selected subset of variables. The development module is configured to select the first model based on a predicted lift of the first model. The validation module is configured to apply the first model to client data acquired subsequent to the selection of the first model. The validation module is configured to compare the predicted lift of the first model to an actual lift of the first model as applied to the client data. The validation module is configured to select one of the first model and a different one of the plurality of models in response to the comparison between the predicted lift of the first model and the actual lift of the first model as applied to the client data.

In other features, the client behavior event corresponds to client attrition. In other features, receiving the use case includes receiving the use case from a user device. In other features, selecting the subset of variables includes applying a plurality of variable selection algorithms to the client data. In other features, the validation module is further configured to verify stability of the selected model. In other features, the development module is configured to select a subset of variables correlated to the client behavior event in response to an input received from a user device.

In other features, the development module is configured to modify non-selected ones of the plurality of models based on the first model. In other features, the validation module is configured to select the first model from the plurality of models by (i) performing cross-validation of the plurality of models to determine respective lifts of the plurality of models and (ii) selecting the first model based on the respective lifts of the plurality of models. In other features, the validation module is configured to perform cross-validation of the plurality of models subsequent to selecting the first model and in accordance with client data acquired subsequent to selecting the first model. In other features, the validation module is configured to select a second model from the plurality of models based on the cross-validation of the plurality of models performed subsequent to selecting the first model.

A method for validating models for predicting a client behavior event includes, using a computing device, receiving a use case corresponding to the client behavior event. The method includes selecting a subset of variables correlated to the client behavior event. The method includes selecting a first model from a plurality of models. Each of the plurality of models is configured to predict the client behavior event using the selected subset of variables. The first model is selected based on a predicted lift of the first model. The method includes applying the first model to client data acquired subsequent to the selection of the first model. The method includes comparing the predicted lift of the first model to an actual lift of the first model as applied to the client data. The method includes selecting one of the first model and a different one of the plurality of models in response to the comparison between the predicted lift of the first model and the actual lift of the first model as applied to the client data.

In other features, the client behavior event corresponds to client attrition. In other features, receiving the use case includes receiving the use case from a user device. In other features, selecting the subset of variables includes applying a plurality of variable selection algorithms to the client data. In other features, the method includes providing the selected subset of variables to a user device. In other features, the method includes selecting a subset of variables correlated to the client behavior event in response to an input received from a user device.

In other features, the method includes modifying non-selected ones of the plurality of models based on the selected first model. In other features, the method includes (i) performing cross-validation of the plurality of models to determine respective lifts of the plurality of models and (ii) selecting the first model based on the respective lifts of the plurality of models. In other features, the method includes performing cross-validation of the plurality of models subsequent to selecting the first model and in accordance with client data acquired subsequent to selecting the first model. In other features, the method includes selecting a second model from the plurality of models based on the cross-validation of the plurality of models performed subsequent to selecting the first model.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a block diagram of an example system configured to develop and validate models for predicting client behavior according to the principles of the present disclosure.

FIG. 2 is a block diagram of an example implementation of a system including a model development system and a model validation system according to the principles of the present disclosure.

FIG. 3 illustrates steps of an example method for developing and validating models for predicting client behavior according to the principles of the present disclosure.

FIG. 4 illustrates steps of an example method for selecting and reducing an amount of variables to be used in a predictive model according to the principles of the present disclosure.

FIG. 5 illustrates steps of an example method for validating and verifying models for predicting client behavior according to the principles of the present disclosure.

In the drawings, reference numbers may be reused to identify similar and/or identical elements.

### DETAILED DESCRIPTION

In a financial investment system, client data may include data indicative of client behavior and, in some examples, the client data may be analyzed to predict future behavior. For example, the client data may be analyzed to predict client retention and attrition (i.e., the client data may be used to determine a likelihood that a particular client will terminate or continue using the financial investment system.

In some examples, the financial investment system may implement various models to analyze the client data and output predictive data regarding client behavior. However, the large amount of client data available reduces the accuracy of the outputs of the models. For example only, for a single client, the client data may include thousands of tables, tens of thousands of variables, and millions of data points. It may be difficult to reduce such a large amount of data to specific data points that are relevant to particular behaviors or events (e.g. a “behavior event”). For example, transactional data alone may not be directly correlated to future behavior events.

Model development and validation systems and methods according to the present disclosure are configured to identify which data (e.g., variables) and models are most relevant to various client behavior events and update the models according to actual results. For example, models and various processes are applied to raw client data to identify the most significant variables for a particular client behavior event (e.g., client retention or attrition behavior) to reduce the amount of client data that is used in subsequent modeling. For example only, thousands of variables (e.g., 6000) for predicting a particular behavior event may be reduced to hundreds (e.g., 100) of variables, and these selected variables are then used in models configured to predict the behavior event. The models and/or variables may be selected based on whether a predicted likelihood (i.e., rate) for the behavior event for a particular client is greater than a natural rate of the behavior event (i.e., a rate at which the behavior event actually occurs amongst a large sample of clients, such as all current and/or previous clients).

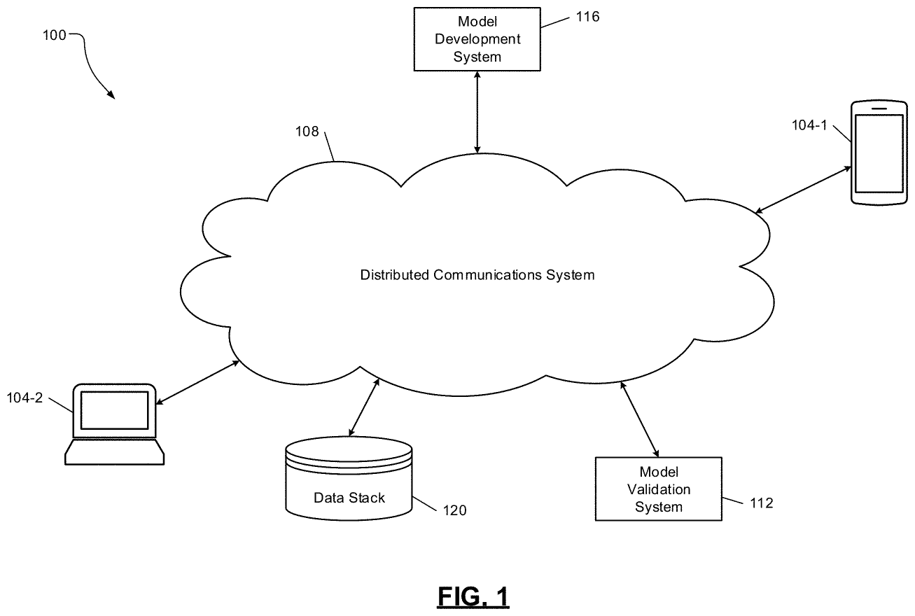

FIG. 1 is an example system 100 configured to develop and validate models for predicting client behavior according to the principles of the present disclosure. One or more user devices—for example, a first user device 104-1, a second user device 104-2, etc. (collectively, user devices 104)—may be used to access a model development system 108, a model validation system 112, and a data stack 116 via a distributed communication system (DCS) 120, such as the Internet, a cloud computing system, etc., and a respective user interface. For example, the user devices 104 may include a smartphone or other mobile device as shown at 104-1, a mobile or desktop computing device as shown at 104-2, etc. Although shown separately, in some examples the model development system 108 and the model validation system 112 may be implemented within a same computing device, server, components of a cloud computing system, etc.

The user devices 104 may be configured to provide access to and, in some examples, execute model development software. For example, the model development software may be stored in and/or executed by the model development system 108 and be accessible via the DCS 120, allowing users to remotely access the model development software using the user devices 104. In some examples, the user devices 104 execute respective user interfaces configured to interact with the model development software, receive inputs, display results, etc., while the model development system 108 executes the model development software. In other examples, the user devices 104 may be configured to store and/or retrieve portions of the model development software to be executed on the user devices 104.

The model validation system 112 is configured to validate the models developed by the model development system 108. For example, the user devices 104 may be configured to provide access to the model validation system 112 to select from among and run (i.e., execute) available models to validate results of the models. For example, selected models are executed to determine whether respective predicted likelihoods (i.e., rates) for a behavior event using the models are greater than a natural rate of the behavior event. A ratio of the predicted likelihood to the natural rate may be referred to a “lift” of the model (e.g., a target response divided by the average response). Models having a lift above a desired threshold (e.g., 1.2) may be retained and implemented (i.e., as production models) while models having a lift below the desired threshold may be discarded and/or adjusted.

The data stack 116 stores data including, but not limited to, raw client data, the models (including model files for both production models and models under development), model development and validation software, etc. The data stored in the data stack 116 may be accessed and retrieved by the model development system 108, the model validation system 112, and the user devices 104 to develop, validate, and run the models. The data stack 116 may correspond to storage and/or memory devices in a single or multiple locations, such as one or more servers, a cloud computing system, databases or data warehouse appliances, etc.

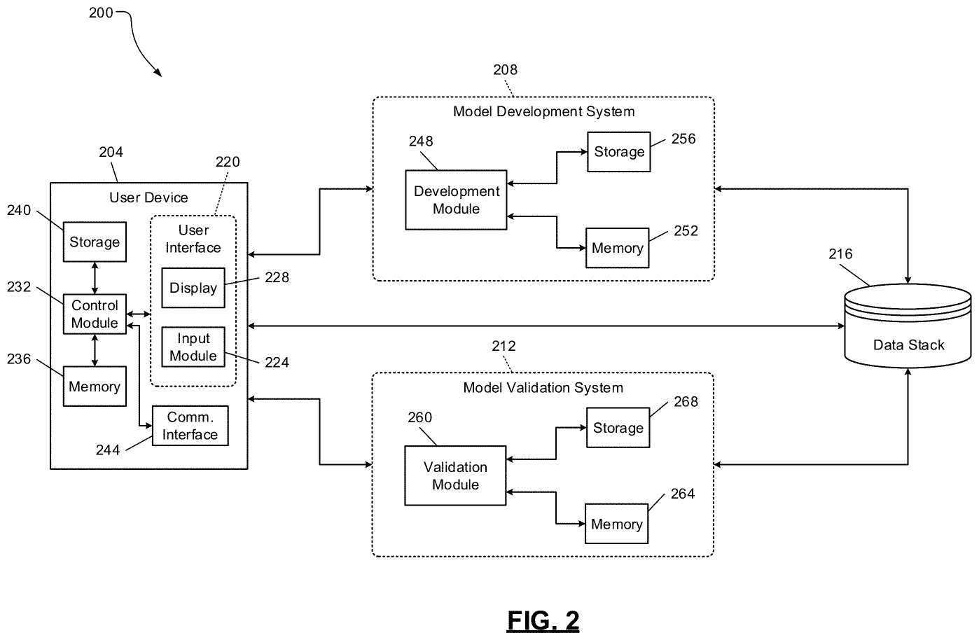

FIG. 2 shows an example implementation of a system 200 including a user device 204, model development system 208, model validation system 212, and data stack 216 configured to develop and validate models for predicting client behavior according to the principles of the present disclosure. For simplicity, the DCS 120 of FIG. 1 is not shown. The user device 204 implements a user interface 220 configured to receive inputs from and display information to a user. For example, the user interface 220 includes an input module 224 configured to receive inputs entered via a touchscreen and/or buttons, a physical or virtual keyboard, voice commands, etc. Conversely, the user interface 220 includes a display 228 configured to display information to the user. In some examples, the user interface 220 corresponds to a touchscreen configured to both receive inputs and display information and images.

The user device 204 includes a control module 232 configured to control functions of the user device 204, including, but not limited to, implementing the user interface 220. For example, the control module 232 may correspond to a processor configured to execute software instructions stored in memory 236 and/or high-capacity storage 240. In various implementations, the software instructions may be loaded into memory 236 from the high-capacity storage 240 and executed solely from within memory 236.

The control module 232 may be further configured to execute model development software (e.g., all or portions of model development software implemented by the model development system 208 and/or stored within the data stack 216) and run and validate models (e.g., using the model validation system 212, models, files, and client data stored in the data stack 216, etc.). The user device 204 communicates with the model development system 208, the model validation system 212, and the data stack 216 via a communication interface 244 (e.g., a wireless communication interface, a cellular communication interface, etc.). The model development system 208, the model validation system 212, and/or the data stack 216 may implement corresponding communication interfaces (not shown).

The model development system 208 includes a development module 248 configured to control functions of the model development system 208, including, but not limited to, communicating with the user device 204 and the data stack 216 to facilitate model development. For example, the development module 248 may correspond to a processor configured to execute software instructions stored in memory 252 and/or high capacity storage 256 and access data stored in the data stack 216, including, but not limited to, raw client data, stored production and development models, model development software, etc.

The development module 248 may correspond to a processing server, service controller, etc. and may be configured to implement an application programming interface (API) for model development accessible by the user device 204. For example, the development module 248 may be responsive to inputs received from the user device 204. Conversely, the model development system 208 provides information to be displayed on the user device 204. In this manner, one or more users may use respective user devices 204 to access the model development system 208 to develop models as described below in more detail.

The model validation system 212 includes a validation module 260 configured to control functions of the model validation system 212, including, but not limited to, communicating with the user device 204 and the data stack 216 to facilitate model validation. For example, the validation module 260 may correspond to a processor configured to execute software instructions stored in memory 264 and/or high capacity storage 268 and access data stored in the data stack 216, including, but not limited to, raw client data, stored production and development models, model validation software, etc. Although shown separately, the model validation system 212 may be implemented within a same computing device, server, components of a cloud computing system, etc. as the model development system 208.

The validation module 260 may be responsive to inputs received from the user device 204. Conversely, the model validation system 212 provides information to be displayed on the user device 204. In this manner, one or more users may use respective user devices 204 to access the model validation system 212 to validate models as described below in more detail.

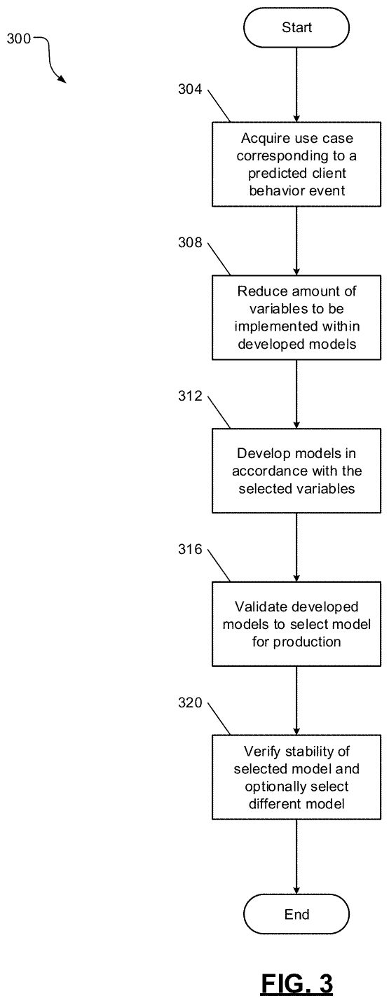

Referring now to FIG. 3, a method 300 for developing and validating models for predicting client behavior according to the principles of the present disclosure is shown. At 304, the method 300 acquires a use case corresponding to a predicted client behavior event. For example only, the use case may correspond to a prediction of a client behavior event such as a prediction of client attrition (i.e., a prediction of whether a particular client will stop using the services of a financial investment system). The acquired use case may correspond to data input using the user device 204 and provided to the model development system 208.

At 308, the method 300 reduces the amount of variables to be implemented within models for the use case. In other words, a subset (e.g., hundreds) of variables that are most relevant to the use case are identified and selected from thousands or tens of thousands of variables. Selected variables may include, but are not limited to, client behavior such as number of trades, types of trades, frequency of trades, dates of trades, etc.

The development module 248 executes a plurality of variable selection algorithms, such as one or more machine learning algorithms applied to the raw client data stored in the data stack 216. The variable selection algorithms include, but are not limited to, algorithms configured to identify variables predictive of a selected client behavior event based on bivariate analysis, correlation analysis, feature importance or feature selection analysis, and principal component regression (PCR) analysis. Output results of the variable selection algorithms may include a selected subset of variables.

For example only, the development module 248 executes the variable selection algorithms for the client behavior event in response to a request from the user device 204. For example, a user may input information corresponding to the client behavior event using the user interface 220. The information may include, for example, the selection of a variable or output value that represents the client behavior event. The development module 248 may provide outputs results of the variable selection algorithms to the user device 204. For example, the output results may include a report of the selected variables.

At 312, models (e.g., a plurality of predictive models for the client behavior event) are developed, in accordance with the selected variables, using the model development system 208. For example, one or more users may develop the models by accessing the model development system 208 using respective ones of the user devices 204. The models developed for a particular use case may include a plurality of different model types. The models may include, but are not limited to, gradient booster models, light gradient booster models, extreme gradient booster models, additive booster models, neural networks, random forest models, elastic net models, stochastic gradient descent models, support vector machine (SVM) models, etc. Each of the models is configured to predict the client behavior event using the select variables.

At 316, the method 300 validates developed models to determine the accuracy of respective models. For example, each model may be validated using cross-validation techniques including, but not limited to, k-fold cross-validation. For example, each model is executed to determine the lift of the model relative to the natural rate of the behavior event. The developed model having the greatest lift may be selected and implemented as the production model. Conversely, the remaining (i.e., non-selected) models may be discarded and/or modified. For example, the remaining models may be modified to operate in accordance with only the variables used by the selected production model.

The model validation system 212 may be configured to automatically validate the developed models (including a current selected production model and non-selected models). For example, the model validation system 212 may automatically (e.g., periodically, in response to updates to the client data stored in the data stack 216, etc.) execute model validation software corresponding to various cross-validation techniques as described above. In other examples, the model validation system 212 may validate all or selected ones of the developed models in response to inputs received at the user device 204.

At 320, the method 300 verifies the stability of the selected production model. For example, the method 300 verifies whether the actual performance of the production model achieves the lift (or, a predetermined lift) for the model as previously determined by the model validation system 212. In some examples, the model validation system 212 may be further configured to apply an algorithm (e.g., the model validation software) to the selected production model using subsequently generated client data to verify that the performance of the model corresponds to the predicted lift of the model. In other words, the model may have been developed and validated, prior to selecting the model, using previously acquired client data. Accordingly, the actual performance of the model using subsequent client data (i.e., data that is acquired after the model is selected as the production model) may be verified to confirm that the previously calculated lift corresponds to the actual lift.

For example only, the model validation system 212 may verify the stability of the model automatically (e.g., periodically, in response to updates to the client data stored in the data stack 216, etc.). Similarly, the model validation system 212 may continue to automatically validate other (i.e., non-selected) developed models using the newly-acquired client data. In some examples, as client data is acquired, the client data corresponding to the variables used by the selected model is provided to the model validation system 212 in real-time for continuous verification of the selected model.

The model validation system 212 may optionally select a different model based on the stability of the production model. For example, the model validation system 212 may select a different model in response to the lift of the selected model decreasing below a threshold a predetermined number of times, in response to an average lift of the selected model over a given period decreasing below a threshold, a lift of one of the non-selected models increasing above the lift of the selected model, etc. In this manner, the model validation system 212 selects the model having the most accurate prediction of the client behavior event as additional client data is acquired.

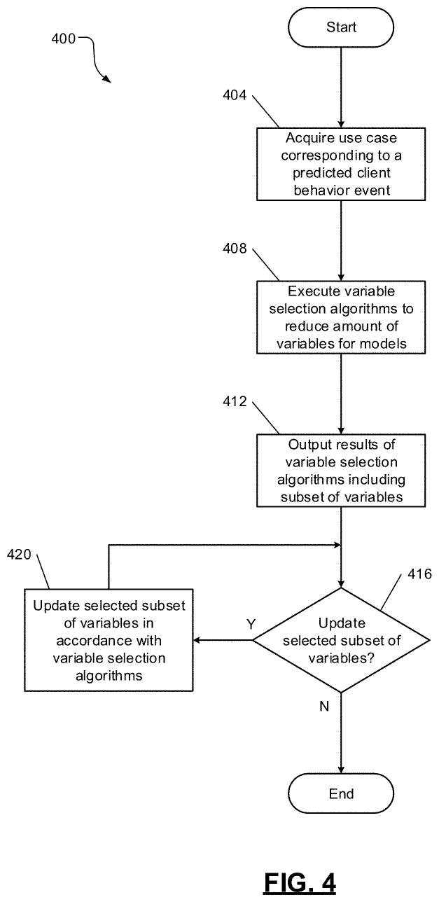

Referring now to FIG. 4, a method 400 for selecting and reducing an amount of variables to be used in a predictive model according to the principles of the present disclosure is shown. At 404, the method 400 acquires a use case corresponding to a predicted client behavior event. The acquired use case may correspond to data input using the user device 204 and provided to the model development system 208. At 408, the method 400 (e.g., the development module 248) executes a plurality of variable selection algorithms, such as one or more machine learning algorithms applied to the raw client data stored in the data stack 216. At 412, the method 400 outputs results of the variable selection algorithms. For example, the development module 248 generates a report of a selected subset of variables and outputs the report to the user device 204.

At 416, the method 400 determines whether to update the selected subset of variables. For example, the method 400 may selectively add or remove variables from the selected subset in response to input from a user received at the user device 204. In other examples, a variable may be added to (or removed from) the selected subset in response to a later determination that the variable is correlated to (or not correlated to) the client behavior. For example, the method 400 may periodically execute the variable selection algorithms as new client data is acquired to update the selected subset of variables. If true, the method 400 continues to 420 to update the selected subset of variables. If false, the method 400 may continue to determine whether to update the selected subset of variables or end.

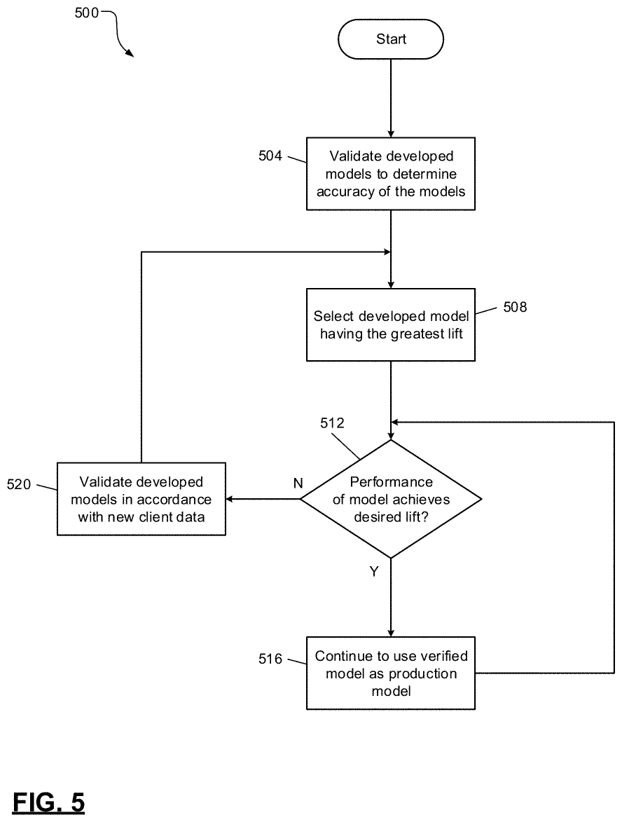

Referring now to FIG. 5, a method 500 for validating and verifying models for predicting client behavior according to the principles of the present disclosure is shown. At 504, the method 500 validates developed models to determine the accuracy of respective models previously developed and stored (e.g., in the data stack 216) by users to determine which model to select as a production model as described above in FIG. 3. For example, each model may be validated using various cross-validation techniques to determine the lift of the model relative to the natural rate of the behavior event. At 508, the method 500 selects the developed model having the greatest lift to be implemented as the production model.

At 512, the method 500 verifies the stability of the selected production model. For example, the method 500 determines whether the actual performance of the production model (i.e., an actual lift of the model) achieves a desired lift in accordance with new client data that is acquired subsequent to the selection of the model as the production model as described above in FIG. 3. If true, the method 500 continues to 516. If false, the method 500 continues to 520. At 516, the method 500 continues to use the verified model as the production model.

At 520, the method 500 selectively validates the developed models (including both the selected model and the non-selected models) in accordance with the new client data. The method 500 may also verify the stability of the selected production model. In various implementations, the method 500 verifies the stability of the model automatically in response to updates to client data. As described above with respect to 320, the method 500 may optionally select a different model based on the stability of the production model.

Control then continues to 508 to select developed model as the production model. In other words, the method 500 may continue to compare the performance of all developed models to select the model having the greatest accuracy (e.g., the greatest lift based on incoming, updated client data).

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are the BLUETOOTH wireless networking standard from the Bluetooth Special Interest Group and IEEE Standard 802.15.4.

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system for validating models for predicting a client behavior event, the system comprising:
a development module configured to
receive a use case corresponding to the client behavior event, and
select a subset of variables correlated to the client behavior event; and
a validation module configured to
select a first model from a plurality of models, wherein each of the plurality of models is configured to predict the client behavior event using the selected subset of variables, and wherein the development module is configured to select the first model based on a predicted lift of the first model,
apply the first model to client data acquired subsequent to the selection of the first model,
compare the predicted lift of the first model to an actual lift of the first model as applied to the client data, and
select one of the first model and a different one of the plurality of models in response to the comparison between the predicted lift of the first model and the actual lift of the first model as applied to the client data.

2. The system of claim 1, wherein the client behavior event corresponds to client attrition.

3. The system of claim 1, wherein receiving the use case includes receiving the use case from a user device.

4. The system of claim 1, wherein selecting the subset of variables includes applying a plurality of variable selection algorithms to the client data.

5. The system of claim 1, wherein the validation module is further configured to verify stability of the selected model.

6. The system of claim 1, wherein the development module is configured to select a subset of variables correlated to the client behavior event in response to an input received from a user device.

7. The system of claim 1, wherein the development module is configured to modify non-selected ones of the plurality of models based on the first model.

8. The system of claim 1, wherein the validation module is configured to select the first model from the plurality of models by (i) performing cross-validation of the plurality of models to determine respective lifts of the plurality of models and (ii) selecting the first model based on the respective lifts of the plurality of models.

9. The system of claim 8, wherein the validation module is configured to perform cross-validation of the plurality of models subsequent to selecting the first model and in accordance with client data acquired subsequent to selecting the first model.

10. The system of claim 9, wherein the validation module is configured to select a second model from the plurality of models based on the cross-validation of the plurality of models performed subsequent to selecting the first model.

11. A method for validating models for predicting a client behavior event, the method comprising:
using a computing device:
receiving a use case corresponding to the client behavior event;
selecting a subset of variables correlated to the client behavior event;
selecting a first model from a plurality of models, wherein each of the plurality of models is configured to predict the client behavior event using the selected subset of variables, and wherein the first model is selected based on a predicted lift of the first model;
applying the first model to client data acquired subsequent to the selection of the first model;
comparing the predicted lift of the first model to an actual lift of the first model as applied to the client data; and
selecting one of the first model and a different one of the plurality of models in response to the comparison between the predicted lift of the first model and the actual lift of the first model as applied to the client data.

12. The method of claim 11, wherein the client behavior event corresponds to client attrition.

13. The method of claim 11, wherein receiving the use case includes receiving the use case from a user device.

14. The method of claim 11, wherein selecting the subset of variables includes applying a plurality of variable selection algorithms to the client data.

15. The method of claim 11, further comprising providing the selected subset of variables to a user device.

16. The method of claim 11, further comprising selecting a subset of variables correlated to the client behavior event in response to an input received from a user device.

17. The method of claim 11, further comprising modifying non-selected ones of the plurality of models based on the selected first model.

18. The method of claim 11, further comprising (i) performing cross-validation of the plurality of models to determine respective lifts of the plurality of models and (ii) selecting the first model based on the respective lifts of the plurality of models.

19. The method of claim 18, further comprising performing cross-validation of the plurality of models subsequent to selecting the first model and in accordance with client data acquired subsequent to selecting the first model.

20. The method of claim 19, further comprising selecting a second model from the plurality of models based on the cross-validation of the plurality of models performed subsequent to selecting the first model.
